(19) United States
(12) Patent Application Publication
(10) Pub. No.: US 2026/0134405 A1
(43) Pub. Date: May 14, 2026

(54) METHOD FOR MANAGING VEHICLE REGULAR INSPECTION IN VEHICLE SUBSCRIPTION SERVICE

(71) Applicants: GROVY INC., Seoul (KR); CAR123-Jasper corp., Seoul (KR)

(72) Inventors: Mi Sung Cho, Seoul (KR); Byung Kwan Jung, Seoul (KR); Young Jin Han, Seoul (KR); Sun Woo Jin, Yongin-si (KR); Ah Young Shin, Goyang-si (KR); YunHwa Song, Suwon-si (KR)

(21) Appl. No.: 18/961,330

(22) Filed: Nov. 26, 2024

(30) Foreign Application Priority Data
Nov. 12, 2024 (KR) 10-2024-0160326

(51) Int. Cl. G06Q 10/20; G06N 3/0455

(52) U.S. Cl. CPC G06Q 10/20; G06N 3/0455

(57) ABSTRACT

The present invention provides a method for managing vehicle inspection for managing vehicle regular inspection in a vehicle subscription service. The present invention may include labeling vehicle-specific data as normal or abnormal using a first model, predicting states for each vehicle at a future time point using the labeled data and a second model, and classifying the states for each vehicle at the future time point into classes according to items requiring repair.

### CROSS REFERENCE TO RELATED APPLICATION

The present application claims priority to Korean Patent Application No. 10-2024-0160326, filed on Nov. 12, 2024, the entire contents of which is incorporated herein for all purposes by this reference.

### BACKGROUND OF THE INVENTION

### Field of the Invention

Embodiments relate to a vehicle subscription service, and more particularly, to a method for managing vehicle regular inspection in a vehicle subscription service.

### Description of the Related Art

A vehicle subscription service is a new concept of a vehicle usage method that has recently been attracting attention along with the spread of sharing economy. The vehicle subscription service may allow users to select and use various types of vehicles as needed without the burden of ownership. The vehicle subscription service has the advantages of lowering initial cost burden, lowering the responsibility for maintenance, and allowing for flexible adaptation to changes in lifestyle.

However, one of the biggest problems in providing the vehicle subscription service is vehicle maintenance and quality management. The performance and safety of vehicles, which are complex mechanical devices, may vary depending on mileage, usage environment, and driving habits, etc. Therefore, it is very important to ensure safe and comfortable driving through proper maintenance of vehicles.

The existing vehicle regular inspection has been made by a method for inspecting the entire vehicle according to a certain cycle or mileage. The method applies the same inspection items regardless of actual conditions of a vehicle, which may lead to unnecessary inspection or excessive costs. In particular, there are often cases where time and resources are wasted inspecting even parts or systems that have not yet encountered any problems.

### SUMMARY OF THE INVENTION

An embodiment may provide a method for lowering cost of vehicle regular inspection in a vehicle subscription service.

An embodiment may provide a method for predicting parts of a vehicle that require maintenance using a deep learning-based failure prediction model in a vehicle subscription service.

According to an embodiment of the present invention, a method for managing vehicle inspection for vehicles may include: labeling vehicle-specific data as normal or abnormal using a first model; predicting states for each vehicle at a future time point using the labeled data and a second model; and classifying the states for each vehicle at the future time point into classes according to items requiring repair.

According to another embodiment of the present invention, an apparatus for managing vehicle inspection for vehicles may include: a memory; and a processor, in which the processor controls to label vehicle-specific data as normal or abnormal using a first model, predict states for each vehicle at a future time point using the labeled data and a second model, and classify the states for each vehicle at the future time point into classes according to items requiring repair.

According to an embodiment of the present invention, by predicting the parts of the vehicle that require maintenance through the deep learning-based failure prediction model in the vehicle subscription service, it is possible to minimize the cost of the regular inspection.

### BRIEF DESCRIPTION OF THE DRAWINGS

FIG. 1 is a conceptual diagram of a method for managing vehicle inspection according to an embodiment of the present invention.

FIG. 2 is a flowchart of a method for managing vehicle inspection using an artificial intelligence model according to an embodiment of the present invention.

FIGS. 3 and 4 illustrate specific implementation examples of the method for managing vehicle inspection according to an embodiment of the present invention.

FIG. 5 is a flowchart of a method for labeling data using a long short-term memory (LSTM) autoencoder according to an embodiment of the present invention.

FIG. 6 is a flowchart of a method for generating final output data using a prediction model and a classifier according to an embodiment of the present invention.

FIG. 7 is a block diagram illustrating a configuration of an apparatus for managing dangerous vehicle inspection according to an embodiment of the present invention.

### DETAILED DESCRIPTION OF THE INVENTION

The present invention may be variously modified and have several embodiments, and thus, specific embodiments will be illustrated in the drawings and be described in detail. However, it is to be understood that the present invention is not limited to a specific embodiment, but includes all modifications, equivalents, and substitutions without departing from the scope and spirit of the present invention.

The terms such as ‘first’ and ‘second’ may be used to describe various components, but these components are not to be interpreted to be limited to these terms. The terms are used to distinguish one component from another component. For example, the first component may be named the second component and the second component may also be similarly named the first component, without departing from the scope of the present invention. The term “and/or” includes a combination of a plurality of related described items or any one of the plurality of related described items.

It is to be understood that when one component is referred to as being “connected to” or “coupled to” another component, one component may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween.

The terms used herein are used only in order to describe specific embodiments rather than limiting the present invention. Singular forms include plural forms unless the context clearly indicates otherwise. It is to be understood that the term “include” or “have” used here specifies the presence of features, numbers, steps, operations, components, parts, or combinations thereof mentioned in the present specification, or combinations thereof, but does not preclude the presence or addition of one or more other features, numbers, steps, operations, components, parts, or combinations thereof.

In this regard, the terms “about,” “substantially,” and the like used throughout the present specification means figures corresponding to manufacturing and material tolerances specific to the stated meaning and figures close thereto, and are used to prevent unscrupulous infringers from unfairly using the disclosure in which accurate or absolute figures are mentioned to help understand the present invention. The term “step (of ˜ing)” or “step of˜” used throughout the specification of the present invention does not mean “step for ˜.”

In the present specification, the term “unit” includes a unit implemented by hardware, a unit implemented by software, and a unit implemented by both the hardware and software. Further, one unit may be implemented by two or more hardware, and two or more units may be implemented by one hardware.

According to an embodiment of the present invention, the “module” or the “unit” may be implemented as a processor and a memory. A “processor” should be interpreted broadly to include a general purpose processor, a central processing unit (CPU), a microprocessor, a digital signal processor (DSP), a controller, a microcontroller, a state machine, and the like. In some environments, the “processor” may refer to an application specific semiconductor (ASIC), a programmable logic device (PLD), a field programmable gate array (FPGA), or the like. The “processor” may also refer to a combination of processing devices, such as a combination of a DSP and a microprocessor, a combination of a plurality of microprocessors, a combination of one or more microprocessors in combination with a DSP core, or any other such configurations. In addition, the “memory” should be interpreted broadly to include any electronic component capable of storing electronic information. The memory may mean various types of processor-readable media such as a random access memory (RAM), a read-only memory (ROM), a non-volatile random access memory (NVRAM), a programmable read-only memory (PROM), an erase-programmable read-only memory (EPROM), an electrically erasable PROM (EEPROM), a flash memory, magnetic or optical data storage, and registers. The memory is said to be in electronic communication with a processor when the processor is capable of reading and/or writing information from and/or to the memory. The memory integrated in the processor is in electronic communication with the processor.

In the present invention, the ‘system’ may include at least one of a server device and a cloud device, but is not limited thereto. For example, the system may be configured to include one or more server devices. As another example, the system may be configured to include one or more cloud devices. As another example, the system may be configured to include both the server device and the cloud device and operate.

In the present specification, some of the operations or functions described as performed by a terminal, an apparatus, or a device may be performed instead in a server connected to the corresponding terminal, apparatus, or device. Similarly, some of the operations or functions described as being performed by a server may be performed in a terminal, an apparatus, or a device connected to the corresponding server.

Unless indicated otherwise, it is to be understood that all the terms used in the specification including technical and scientific terms have the same meaning as those that are generally understood by those who skilled in the art. Terms generally used and defined by a dictionary should be interpreted as having the same meanings as meanings within a context of the related art and should not be interpreted as having ideal or excessively formal meanings unless being clearly defined otherwise in the present specification.

Hereinafter, exemplary embodiments of the present invention will be described in more detail with reference to the accompanying drawings. In order to facilitate the entire understanding in describing the present invention, the same components will be denoted by the same reference numerals throughout the accompanying drawings, and an overlapped description for the same components will be omitted.

The present invention relates to a vehicle subscription service, and describes a method for managing vehicle regular inspection in a vehicle subscription service. Specifically, the present invention proposes a technology for reducing the time and cost for vehicle regular inspection by preventing unnecessary inspection and performing inspection only on necessary parts. In the following description, the technology proposed in the present invention is referred to as a ‘method for managing vehicle inspection.’

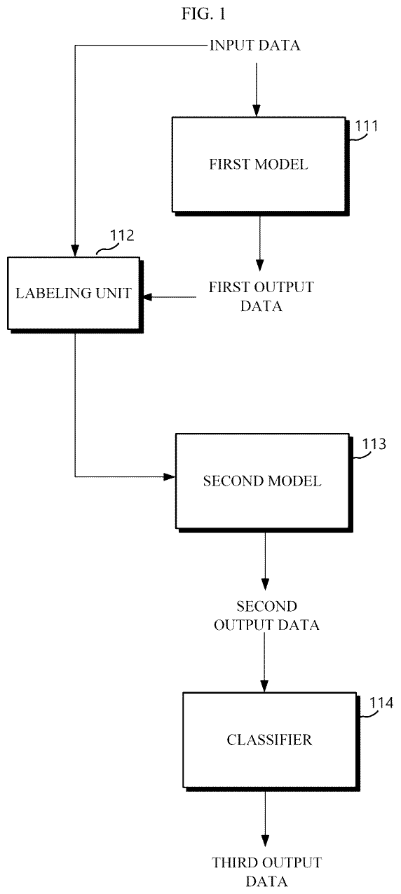

FIG. 1 is a conceptual diagram of a method for managing vehicle inspection according to an embodiment of the present invention.

Referring to FIG. 1, the method for managing vehicle inspection is performed using a first model 111, a labeling unit 112, a second model 113, and a classifier 114. Input data may be input to the first model 111. The first model 111 generates first output data and then provides the first output data to the labeling unit 112. The labeling unit 112 determines a labeling criterion using the first output data and labels the input data according to the determined criterion. Normal/abnormal information is added to the input data by the labeling. In the following descriptions, the normal input data means that information on a vehicle indicated by the input data is included in a normal category. The abnormal input data means that the information on the vehicle indicated by the input data is not included in the normal category.

The data labeled by the labeling unit 112 is input to the second model 113. The second model 113 generates second output data using the labeled data. The second output data includes information on items that require inspection in the corresponding vehicle. The classifier 114, which receives the second output data, generates optimized results to lower inspection costs. The optimized results are included in third output data. Specifically, information on vehicle-specific inspection priorities, high-risk vehicles, etc., are additionally extracted.

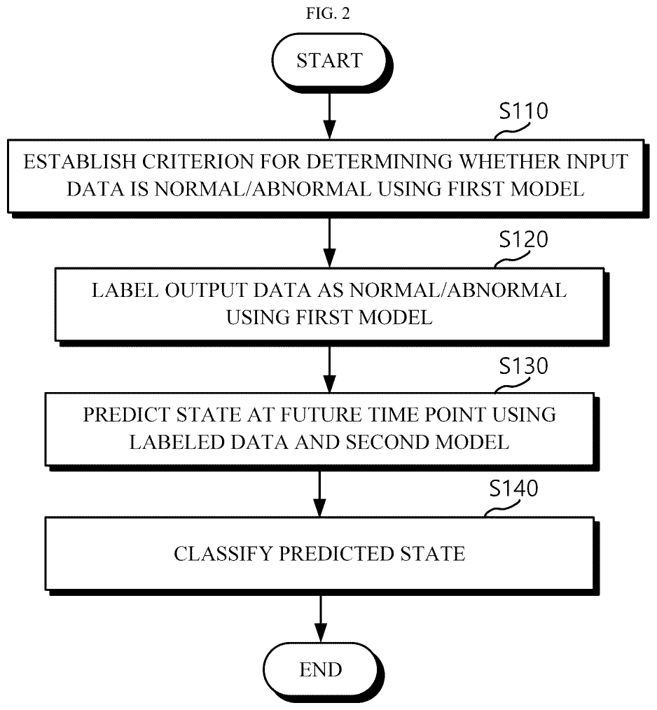

FIG. 2 is a flowchart of a method for managing vehicle inspection using a digital twin according to an embodiment of the present invention.

Referring to FIG. 2, in operation S110, the method for managing vehicle inspection may establish criteria for determining whether the input data is normal/abnormal using the first model. To this end, the method for managing vehicle inspection may use a long short-term memory (LSTM) autoencoder as the first model. The LSTM autoencoder is an autoencoder implemented by applying encoder-decoder LSTM architecture to sequence data. The criteria for distinguishing between the normal/abnormal data may be established by the output data generated by the LTSM autoencoder using a training dataset as the input data.

Thereafter, the labeling is performed on the output data using a test dataset as the input data. In operation S120, the method for managing vehicle inspection may perform the labeling on the output data using the first model. Here, the training dataset and the test dataset are data related to the vehicle, and may include at least one of vehicle operation data, vehicle maintenance data, vehicle accident data, and driver data.

In operation S130, the method for managing vehicle inspection predicts a state at a future time point using the labeled data and the second model. To this end, a vehicle inspection method may use a prediction model, which is implemented as a trained deep learning model, as the second model. The prediction model may predict future trends and behavior patterns based on past data through intelligent data analysis. For analysis, the prediction model may estimate one or more parameters using the collected past data. For example, the prediction model may be one of a classification model, a clustering model, a forecast model, an outliers model, or a time series model. In addition, the prediction model may perform prediction using one of regression analysis, a decision tree, a K-nearest neighbor (K-NN) algorithm, support vector machines (SVM), artificial neural networks, or ensemble methods. The predicted results are acquired in the form of output data, and the output data includes information on maintenance items. For example, the information on the maintenance items may include the probability of failure for each maintenance item.

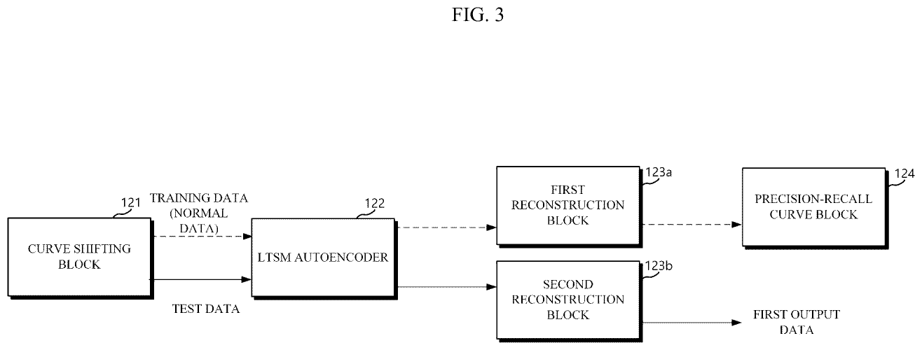

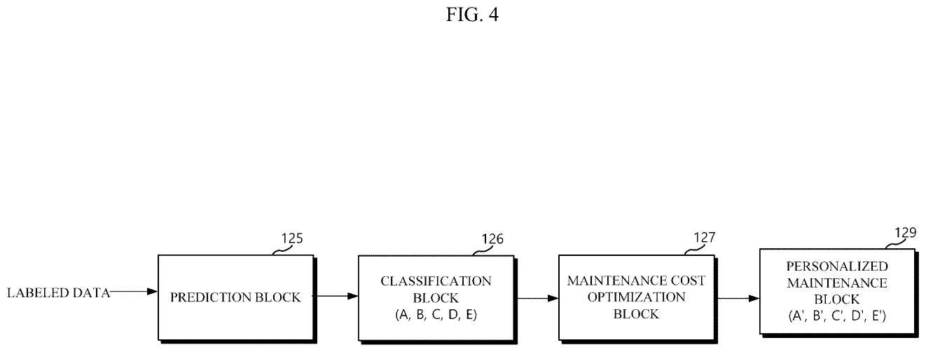

In operation S140, the method for managing vehicle inspection classifies the predicted state. Specifically, the method for managing vehicle inspection optimizes the output data to reduce inspection costs. To this end, the method for managing vehicle inspection may consider statistical data on an inspection cycle for each item, an inspection price for each item, a risk of failure for each item, etc. In addition, the method for managing vehicle inspection may optimize operating costs in consideration of a consumable replacement cycle, visit cycle for each vehicle, and maintenance unit prices for each vehicle using a regression model. FIGS. 3 and 4 are specific implementation examples of the method for managing vehicle inspection according to an embodiment of the present invention. FIGS. 3 and 4 illustrate architecture for optimizing a failure/disorder prediction model based on an LSTM autoencoder and optimizing integrated management costs by applying predictive maintenance based on failure prediction. Blocks 121 to 124 illustrated in FIG. 3 may be included in the first model 111. Blocks 121 and 126 illustrated in FIG. 4 may be included in the second model 113. Blocks 127 and 129 illustrated in FIG. 4 may be included in the classifier 114.

First, the input data is preprocessed by a curve shifting block 121. The curve shifting block 121 handles time series data. The input data is composed of variables such as time and x1, x2, and x3, and the curve shifting block 121 preprocesses the corresponding data. The curve shifting block 121 shifts a time axis of the variables in the data so that the model may predict the future using data at time point t−n. As a result, it is possible to perform model training that considers a temporal correlation of data.

An example of the preprocessing by the curve shifting block 121 is as follows. As an example of original data before applying the curve shifting, the values according to the flow of time are as shown in Table 1.

TABLE 1

| Time (t) | Value |
|---|---|
| t1 | 20 |
| t2 | 22 |
| t3 | 24 |
| t4 | 23 |
| t5 | 25 |

Table 1 shows the variable values recorded at each time point as time passes from t1 to t5. Data is shifted so that data at a previous time point may be compared with a current time point through the curve shifting. For example, data may be shifted by n time points. For example, data at time point t−1 may be shifted to time point t. The results are as shown in Table 2.

TABLE 2

| Time (t) | Value (t) | Value (t-1) |
|---|---|---|
| t2 | 22 | 20 |
| t3 | 24 | 22 |
| t4 | 23 | 24 |
| t5 | 25 | 23 |

In Table 2, a value t−1 is the result of matching data before one time point to a current time point. For example, a current value at time point t3 is 24, and a value at a previous time point t2 is 22.

In this way, by comparing past data with current data through the curve shifting, the model may train change patterns of values over time. For example, the model may identify how the values at the previous time point affect the current value, and predict future data based on the identified values.

In this case, the curve shifting may also shift data by multiple time points. For example, when data at time point t−2 as well as time point t−1 is compared, data may be processed as in Table 3.

TABLE 3

| Time (t) | Value (t) | Value (t-1) | Value (t-2) |
|---|---|---|---|
| t3 | 24 | 22 | 20 |
| t4 | 23 | 24 | 22 |
| t5 | 25 | 23 | 24 |

As shown in Table 3, when data at time point t−2 is added, the model may be trained to view and predict data by two time points.

The data provided as the input data may include at least one of the vehicle operation data, the vehicle maintenance data, the vehicle accident data, and the driver data.

TABLE 4

| Data | Key Information |
|---|---|
| Vehicle | vehicle type, fuel type, displacement, driving period, |
| operation data | mileage, etc. |
| Vehicle | vehicle type, maintenance item, maintenance cost, |
| maintenance | maintenance area, etc. |
| data | |
| Vehicle | vehicle type, accident date, driving period, accident |
| accident data | item, accident repair details, etc. |
| Driver data | accident history, driving period (factors to increase the |
| | number of times of inspections when a driver |
| | has a lot of accident history or drives aggressively) |

Specifically, vehicle operation data may be related to at least one of an EV battery, a door, an engine output, a shock sensor, an EV system, memory, a fuel system, a crank angle/cam angle, a NOx sensor, a mirror, fuel injection timing, power steering, PCM/ECM/TCM, a transmission, fuel moisture, an intake system, PCM/TCM/TCU, transmission oil temperature, fuel pressure, intake pressure, a PM sensor, exhaust pressure, a fuel temperature sensor, intake temperature, TCU/TCM, exhaust control, fuel flow, intake control, TPMS, exhaust gas, fuel control, intake/exhaust control, a warning light, a battery, fuel cutoff, intake air, a horn, a brake, fuel tank pressure, an ignition system, internal temperature control, an oxygen sensor, a fuel pump, control communication, coolant, a thermostat, a preheater, evaporated gas, a coolant quantity, a throttle actuator, an oil change lamp, an engine cooling system, an accelerator position, an oil level switch, a cooling fan, an accelerator position sensor, an oil temperature sensor, a knock sensor, an engine RPM, an automatic transmission, atmospheric pressure, engine high temperature, an immobilizer, an atmospheric temperature sensor, engine start cutoff, an injector, vacuum pressure, engine oil pressure, and engine oil temperature.

In addition, the vehicle maintenance data may be related to at least one of a gasket system, automatic transmissions, manual transmissions, an interior material system, an exterior material system, switch/relay systems, a cooling system, a wiper, an air conditioning system, a power system, an ignition system, an engine system, an exhaust system, a brake system, oils, belts, a steering system, manual transmissions, accessories, washer fluid/glass/bulbs, a timing belt, a sensor system, electrical/wiring/combustion systems, a tire/wheel system, a suspension system, and an intake system.

In addition, the vehicle accident data may be related to at least one of an interior material system, automatic transmissions, a timing belt, a cooling system, an exterior material system, a tire/wheel system, a power train, oils, an intake system, a sensor system, electrical/wiring/horn systems, a suspension system, manual transmissions, an ignition system, a fuel system, a switch/relay system, a brake system, a steering system, and an engine system.

The detailed data described above may be used as input data after being grouped into similar groups. The similar groups for classifying the detailed data may correspond to classes to which the predicted data is classified. The classes may be classes in which the predicted data is classified by the classification block 126.

Next, an LSTM autoencoder 122 performs compression and reconstruction using the preprocessed input data. The LSTM is a neural network suitable for handling time series data and is used in an autoencoder structure. The input data is compressed through the encoder, and the compressed input data is reconstructed again through a decoder. That is, the encoder reduces a dimension of the input data to summarize only important features, and the decoder reconstructs the data reduced by the encoder back to original data. In this process, the LSTM autoencoder 122 extracts the important features of the input data.

The LSTM autoencoder 122 can select normal data and abnormal data among multiple data items. The LSTM autoencoder 122 is used to train patterns from time series data or sequential data and perform abnormal detection. In particular, the LSTM autoencoder 122 may train the important features while compressing data and then reconstructing data again, and distinguish the normal and abnormal data using these features.

When the training is completed, the normal data will be relatively well reconstructed, and the abnormal data will not be relatively well reconstructed. Therefore, when the LSTM autoencoder 122 is trained, a training data set composed only of the normal data is used, and training is performed so that the error between the input and output is minimized. That is, a first reconstruction block 123a calculates a mean square error (MSE) between the input and output of the LSTM autoencoder 122. Here, the LSTM autoencoder 122 may be trained so that the MSE is minimized. Here, the MSE is a loss function that measures the difference between the reconstructed output and the original input. The model is trained in a way to minimize the reconstruction loss, that is, the difference between the input data and the output data. Accordingly, the LSTM autoencoder 122 may be trained with a model that reconstructs the normal data well.

A precision-recall curve block 124 determines a threshold of the reconstruction loss (e.g., MSE) for determining normality and abnormality based on the trained results using the training data set. The precision-recall curve is a curve that evaluates how accurately a model may distinguish between the normal and abnormal data. The precision refers to a ratio of predictions actually correctly made by a model to all predictions made by the model, and the recall refers to how many the model correctly identifies the actual normal data. An optimal threshold is set on the curve so that the performance of the model may be adjusted.

Thereafter, a test data set passes through the LSTM autoencoder 122, and the MSE is calculated by the second reconstruction block 123b. Here, the determined MSE is compared with the threshold determined by the precision-recall curve block 124. Based on the result of the comparison with the threshold, labeling as normal or abnormal is performed on each data item included in the test data set. That is, the precision-recall curve block 124 labels the predicted results for each data item included in the test data set as normal or abnormal based on the set threshold. That is, when the reconstruction loss is less than or equal to the threshold, the input data for test are labeled as normal, and when the reconstruction loss exceeds the threshold, the input data for test are labeled as abnormal. This process identifies and displays what state the data is in.

The prediction block 125 predicts future data, i.e., data at time point t+n, based on the trained model. The prediction block 125 includes a prediction model. For example, the prediction model may include one of the classification model, the clustering model, the forecast model, the outliers model, or the time series model.

The classification block 126 classifies the data predicted by the prediction block 125 into specific classes (e.g., A, B, C, D, E, etc.). This process refers to a classification task that determines which category the state predicted by the model belongs to. For example, A may be a tire, B may be an engine system, C may be a braking system, D may be an ignition system, E may be a wiring system, etc. The classification block 126 may place the corresponding vehicle in a group with the highest probability of failure, or may place the corresponding vehicle in a group with a probability of failure of 70% or higher.

The maintenance cost optimization block 127 optimizes operating costs. For example, the consumables replacement cycle, the visit cycle for each vehicle, the maintenance unit prices for each vehicle, etc., may be considered. For example, the maintenance cost optimization block 127 may operate based on the regression model. For example, a nonlinear cost regression model, which is a type of the regression model, may be used. The nonlinear cost regression model is a type of statistical model that may capture nonlinear and dynamic characteristics of a cost function. The nonlinear cost regression model may help estimate parameters of a cost function, test hypotheses about a cost structure, and predict costs for various scenarios. In addition, the nonlinear cost regression model may provide insight into the causes of cost inefficiency, trade-off between various cost causes, and potential cost savings through improvement in specific aspects of a production process. Using the nonlinear cost regression model, a wide range of cost functions, such as power, exponential, logarithmic, polynomial, and sigmoid functions, that are not adequately represented by a linear or quadratic model, may be effectively processed. To use the regression model, a regular maintenance data 128 may be utilized. The regular maintenance data 128 includes information on an inspection cycle for each item, inspection prices for each item, the risk of failure for each item, etc.

The optimized result is provided as the personalized maintenance block 129. The personalized maintenance block 129 sorts the classification data in consideration of inspection priorities for each vehicle, a vehicle with high risk, etc. Specifically, the personalized maintenance block 129 may prioritize vehicles within each class determined by the classification block 126. That is, by considering that all maintenance items of a vehicle do not have the same urgency or importance, a high priority may be assigned to vehicles expected to fail in items with high urgency. In addition, high priorities may be assigned to vehicles expected to fail in items with low repair or inspection costs.

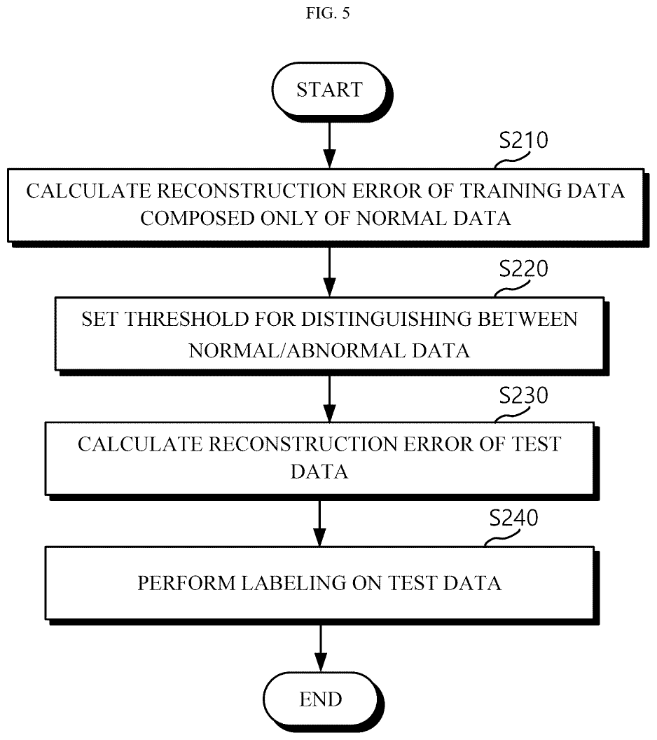

FIG. 5 is a flowchart of a method for labeling data using the LSTM autoencoder according to an embodiment of the present invention.

Referring to FIG. 5, in operation S210, the method for managing vehicle inspection calculates a reconstruction error of the training data composed only of the normal data. The reconstruction error is a value indicating the reconstruction accuracy of the LSTM autoencoder model, and indicates the degree of difference between the input and output of the LSTM autoencoder. In this case, the reconstruction error values for the training data composed only of the normal data are calculated. That is, the method for managing vehicle inspection inputs the training data composed only of the normal data to the LSTM autoencoder model to compress and reconstruct the data and calculate the reconstruction error values indicating the accuracy of the reconstruction.

In operation S220, the method for managing vehicle inspection sets a threshold for distinguishing between the normal and abnormal data. The threshold is for the reconstruction error value, and when some data is compressed and reconstructed by the LSTM autoencoder, the normal data and abnormal data may be distinguished by comparing the threshold with the reconstruction error determined by the input data and the output data. For example, the method for managing vehicle inspection may set a threshold based on the precision-recall curve. For example, the threshold may be set to be lower than or equal to the reconstruction error of the training data composed only of the normal data.

In operation S230, the method for managing vehicle inspection calculates a reconstruction error of test data. The test data may include the normal data and the abnormal data. That is, the method for managing vehicle inspection inputs the training data composed only of the normal data to the LSTM autoencoder model to compress and reconstruct the data and calculate the reconstruction error values indicating the accuracy of the reconstruction. In this case, since the LSTM autoencoder is trained using the normal data, the reconstruction error of the normal data will be calculated to be relatively small, and the reconstruction error of the abnormal data will be calculated to be relatively large.

In operation S240, the method for managing vehicle inspection performs the labeling on the test data. Specifically, the method for managing vehicle inspection may compare the reconstruction error of the test data with the threshold, and label the test data as normal when the reconstruction error is smaller than the threshold and label the test data as abnormal when the reconstruction error is greater than or equal to the threshold. Here, the items constituting the input data, which is the test data, include at least one of the vehicle operation data, the vehicle maintenance data, the vehicle accident data, and the driver data, and the abnormal label means that specific parts need to be repaired.

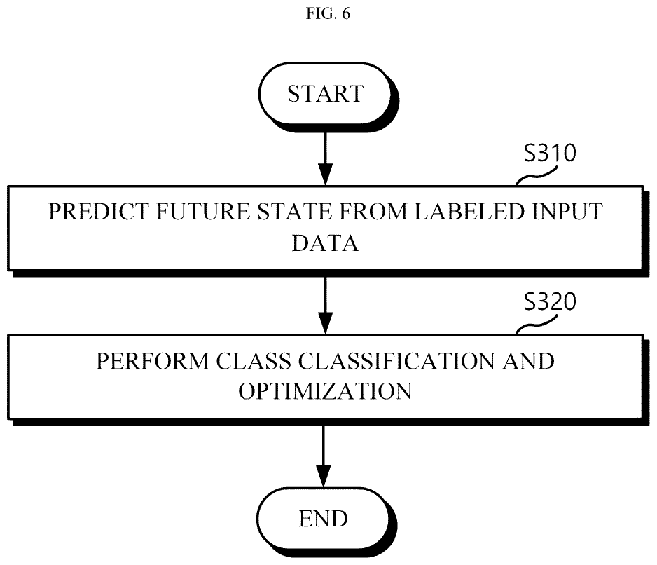

FIG. 6 is a flowchart of a method for generating final output data using a prediction model and a classifier according to an embodiment of the present invention.

Referring to FIG. 6, in operation S310, the method for managing vehicle inspection predicts future states from the labeled input data. The method for managing vehicle inspection may use a model trained to predict the future states from the labeled input data. The method for managing vehicle inspection predicts future states for each vehicle from the labeled input data for each of the plurality of vehicles. As a result, for each vehicle, results may be obtained as to which maintenance item needs to be repaired with a certain degree of probability. For example, the maintenance items considered may include at least one of battery discharge, tire puncture and wear, engine overheating (overheating), a brake system problem, a fuel system problem, an electrical system problem, and a transmission problem.

In operation S320, the method for managing vehicle inspection performs class classification and optimization. The method for managing vehicle inspection classifies vehicles into multiple classes based on the previously determined future states for each vehicle. Here, the class is defined for each maintenance item. That is, the method for managing vehicle inspection classifies vehicles with maintenance items predicted to require repair with a probability of a certain level or higher so that the vehicles belong to a class corresponding to the corresponding maintenance item. Accordingly, each class include at least one vehicle having a future state that requires repair for the maintenance item corresponding to the class with a probability of a certain level or higher. The method for managing vehicle inspection may prioritize vehicles belonging to each class in consideration of the inspection costs for each maintenance item, the inspection cycle required for each maintenance item, and the urgency for each maintenance item. Here, the urgency for each maintenance item may be determined based on the degree of impact on the vehicle in the event of a failure (e.g., high urgency when the vehicle cannot be driven). To this end, the method for managing vehicle inspection may use the regression model.

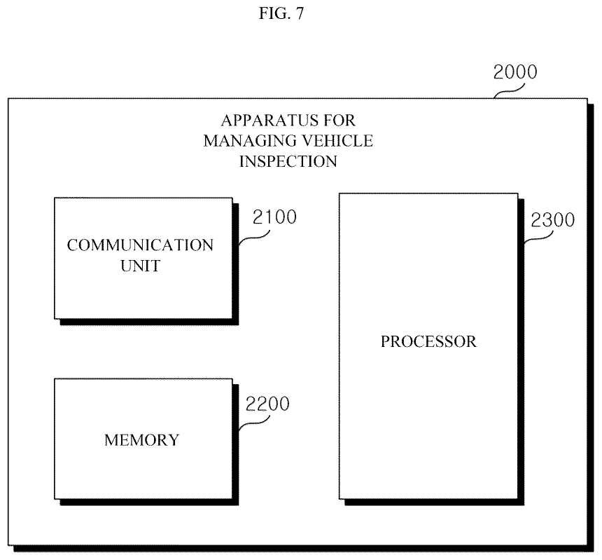

FIG. 7 is a block diagram illustrating a configuration of an apparatus for managing vehicle inspection according to an embodiment of the present invention.

An apparatus 2000 for managing vehicle inspection illustrated in FIG. 7 may perform a literature comparison method described with reference to FIGS. 1 to 6. The apparatus 2000 for managing vehicle inspection may include a communication unit 2100, a memory 2200, and a processor 2300. The apparatus 2000 for managing vehicle inspection may be implemented as, but is not limited to, an embedded board, a smart phone, a tablet PC, a PC, a smart TV, a mobile phone, a personal digital assistant (PDA), a laptop, a vehicle, and other mobile or non-mobile computing devices.

The communication unit 2100 may include one or more components that cause the apparatus 2000 for managing vehicle inspection to communicate with external electronic devices. The communication unit 2100 may include a short-range wireless communication unit (not illustrated), a mobile communication unit (not illustrated), and a broadcast receiving unit (not illustrated). The short-range wireless communication unit may include, but is not limited to, a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi direct (WFD) communication unit, an UltraWideband (UWB) communication unit, an Ant+ communication unit, etc. The mobile communication unit transmits or receives wireless signals to or from at least one of a base station, an external terminal, and a server on a mobile communications network. The wireless signal may include various types of data according to transmission and reception of a voice call signal, a video call signal, or a text/multimedia message. The broadcast receiving unit receives a broadcast signal and/or broadcast-related information from the outside through a broadcast channel. The broadcast channel may include a satellite channel and a terrestrial channel. According to the implementation example, the communication unit 2100 may not include the broadcast receiving unit. The apparatus 2000 for managing vehicle inspection may receive order logs for existing items, attribute information for existing items, and attribute information for new items from an external device through the communication unit 2100.

The memory 2200 may store a program for processing and controlling the processor 2300, and may store data input to or output from the apparatus 2000 for managing vehicle inspection. In addition, the memory 2200 may store information on candidate literatures searched by the apparatus 2000 for managing vehicle inspection.

The memory 2200 may include at least one type of storage medium of a flash memory type, a hard disk type, a multimedia card micro type, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The processor 2300 may typically control the overall operation of the apparatus 2000 for managing vehicle inspection. The processor 2300 may perform the literature comparison method described with reference to FIGS. 1 to 5 by executing programs stored in the memory 2200. The processor 2300 may be implemented as a central processing unit (CPU), and also be implemented as a processing device such as a graphic processing unit (GPU), a neural processing unit (NPU), etc.

The foregoing are specific embodiments for carrying out the present invention. The present invention will include not only the above-described embodiments, but also embodiments that can be simply or easily changed in design. In addition, the present invention will also include technologies that can be easily modified and implemented using the embodiments. Therefore, the scope of the present invention should not be limited to the above-described embodiments and should be defined by not only the claims to be described later but also those equivalent to the claims of the present invention.

What is claimed is:

1. A method for managing vehicle inspection for vehicles provided to a vehicle subscription service, performed by at least one processor, the method comprising:
labeling vehicle-specific data as normal or abnormal using a first model;
predicting states for each vehicle at a future time point using the labeled data and a second model; and
classifying the states for each vehicle at the future time point into classes according to items requiring repair.

2. The method of claim 1, wherein the first model includes a long short-term memory (LSTM) autoencoder, and
the labeling is performed based on results of compressing and reconstructing the data using the first model.

3. The method of claim 2, wherein the labeling is performed as abnormal when a value indicating a difference between the data and the results of compressing and reconstructing the data is greater than or equal to a threshold, and as normal when a value indicating the difference is less than the threshold.

4. The method of claim 3, wherein the threshold is determined based on values indicating the difference between normal data and results of compressing and reconstructing the normal data using the first model.

5. The method of claim 1, further comprising:
applying curve shifting to the vehicle-specific data to perform preprocessing.

6. The method of claim 1, wherein the vehicle-specific data includes at least one of vehicle operation data, vehicle maintenance data, vehicle accident data, and driver data, and
detailed data of the vehicle operation data is classified into similar groups corresponding to the classes.

7. The method of claim 1, wherein the classifying of the states for each vehicle at the future time point into the classes according to the items requiring repair includes classifying a vehicle having a maintenance item predicted to require repair with a probability of a certain level or higher by the second model so that the vehicle belongs to a class corresponding to the corresponding maintenance item.

8. The method of claim 1, further comprising:
prioritizing the vehicles belonging to each of the classes,
wherein the vehicles are prioritized by being optimized based on a regression model in consideration of costs for each maintenance item, an inspection cycle required for each maintenance item, and urgency.

9. The method of claim 8, wherein the prioritizing includes assigning a relatively higher priority to a vehicle expected to fail in an item having high urgency.

10. The method of claim 8, wherein the prioritizing step includes assigning a relatively higher priority to a vehicle expected to fail in an item having a relatively lower repair or inspection cost.

11. An apparatus for managing vehicle inspection for vehicles provided to a vehicle subscription service, the apparatus comprising:
a memory; and
a processor,
wherein the processor controls to label vehicle-specific data as normal or abnormal using a first model,
predict states for each vehicle at a future time point using the labeled data and a second model, and
classify the states for each vehicle at the future time point into classes according to items requiring repair.
